(19) United States
(12) Patent Application Publication
(10) Pub. No.: US 2004/0156405 A1
(43) Pub. Date: Aug. 12, 2004

(54) Light emitting device and display unit using it

(76) Inventors: Nobutoshi Asai, Kanagawa (JP); Jiro Yamada, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/701,307

(22) Filed: Nov. 4, 2003

(30) Foreign Application Priority Data
Nov. 11, 2002 (JP) P2002-326592

(51) Int. Cl. H01S 3/14

(52) U.S. Cl. 372/39

(57) ABSTRACT

The invention provides a light emitting device which can improve image quality by reducing outside lights reflection or reflection of outside scenes. The light emitting device has a resonator structure which resonates lights generated in a light emitting layer between a first end and a second end to extract these lights from the second end side. Respective strengths and phases of reflected lights of an outside light on the first end side and the second end side, are adjusted so that reflectance of the outside light in a resonant wavelength which is incident from the second end side becomes 20% or less. Specifically, construction is made so that their strengths are almost the same, and their phases are approximately inverted. The strengths of the reflected lights are adjusted by materials and thicknesses of a first electrode and a second electrode. The phases of the reflected lights are adjusted by an optical distance between the first end and the second end.

### BACKGROUND OF THE INVENTION

1. Field of the Invention

The present invention relates to a light emitting device having a resonator structure which resonates lights generated in a light emitting layer between a first end and a second end and a display unit using it, and more particularly such an organic light emitting device comprising such a resonator structure and a display unit using it.

2. Description of the Related Art

As a display unit instead of a liquid crystal display, an organic light emitting display which uses organic light emitting devices has been noted. The organic light emitting display has characteristics that its visual field angle is wide and its power consumption is low since it is a self-light emitting type display. The organic light emitting display is also thought of as a display having sufficient response to high-definition high-speed video signals, and is under development toward the practical use.

So far, regarding the organic light emitting devices, trials to control lights generated in a light emitting layer, for example, a trial to improve color purity of light emitting colors and light emitting efficiency by introducing a resonator structure have been made (for example, refer to International Publication No. 01/39554).

However, regarding the organic light emitting device, a problem that image quality of display images is deteriorated by outside lights reflection or reflection of outside scenes on the display surface is left. In order to solve this problem, for example, arranging a circular polarizing plate on the display surface side has been proposed. However, since in this construction, the lights generated in the light emitting layer are also attenuated to 50% or less by the circular polarizing plate, luminance is lowered. Assuring the luminance causes raised power consumption or shortened life of the display.

In addition, a method that light absorption color filters corresponding to each light emitting color or fluorescent color filters are combined has been proposed. In this method, since reflectance in wavelengths near light emitting colors is not lowered so much though reflectance in wavelengths other than that of the light emitting colors of picture elements is greatly lowered, influence by outside lights cannot be sufficiently relieved.

### SUMMARY OF THE INVENTION

In light of the foregoing, it is an object of the invention to provide a light emitting device which can improve image quality by reducing outside lights reflection or reflection of outside scenes and a display unit using it.

A light emitting device according to the invention has a resonator structure which resonates lights generated in a light emitting layer between a first end and a second end, and which extracts the lights at least from the second end side, wherein reflectance of outside lights in resonant wavelengths which is incident from a second end is 20% or less.

A display unit according to the invention comprises light emitting devices having a resonator structure which resonates lights generated in a light emitting layer between a first end and a second end, and extracting lights at least from the second end side, wherein reflectance of outside lights in resonant wavelengths which is incident from the second end side of the light emitting device is 20% or less.

Since in the light emitting device and the display unit according to the invention, reflectance of outside lights in resonant wavelengths is 20% or less, reflectance of outside lights in wavelengths near light emitting colors becomes small, and reflection of outside scenes is prevented.

Other and further objects, features and advantages of the invention will appear more fully from the following description.

### BRIEF DESCRIPTION OF THE DRAWINGS

FIG. 1 is a cross sectional view showing a construction of a display unit using organic light emitting devices which are light emitting devices according to a first embodiment of the invention;

FIG. 2 is a cross sectional view showing an enlarged construction of an organic layer in the organic light emitting devices illustrated in FIG. 1;

FIG. 3 is a cross sectional view showing an enlarged construction of an organic layer in the organic light emitting device illustrated in FIG. 1;

FIG. 4 is a figure showing light absorptance in relation to thickness where extinction coefficient is −4i, and real part refractive index is varied in increments of 0.1 in the range from 0.1 to 1.1;

FIG. 5 is a cross sectional view showing as a model, reflection of an outside light in the organic light emitting device illustrated in FIG. 1;

FIG. 6 is a figure showing light reflectance in relation to thickness where extinction coefficient is −4i, and real part refractive index is varied in increments of 0.1 in the range from 0.1 to 1.1;

FIG. 7 is a figure showing light reflectance in relation to thickness where refractive index is 0.5 and extinction coefficient is varied in increments of 0.5 in the range from 0 to −5.0;

FIG. 8 is a figure showing light absorptance in relation to thickness where refractive index is 0.5 and extinction coefficient is varied in increments of 0.5 in the range from 0 to −5.0;

FIGS. 9A and 9B are cross sectional views showing a method manufacturing the display unit illustrated in FIG. 1 in order of processes;

FIGS. 10A and 10B are cross sectional views showing processes following FIGS. 9A and 9B;

FIG. 11 is a cross sectional view showing a construction of an organic light emitting device which is a light emitting device according to a second embodiment of the invention;

FIG. 12 is a figure showing reflection spectrums of outside lights in organic light emitting devices according to Example 1 of the invention; and

FIG. 13 is a figure showing reflection spectrums of outside lights in organic light emitting devices according to Example 2 of the invention.

### DETAILED DESCRIPTION OF THE PREFERRED EMBODIMENTS

Embodiments of the invention will be described in detail hereinbelow with reference to the drawings.

### First Embodiment

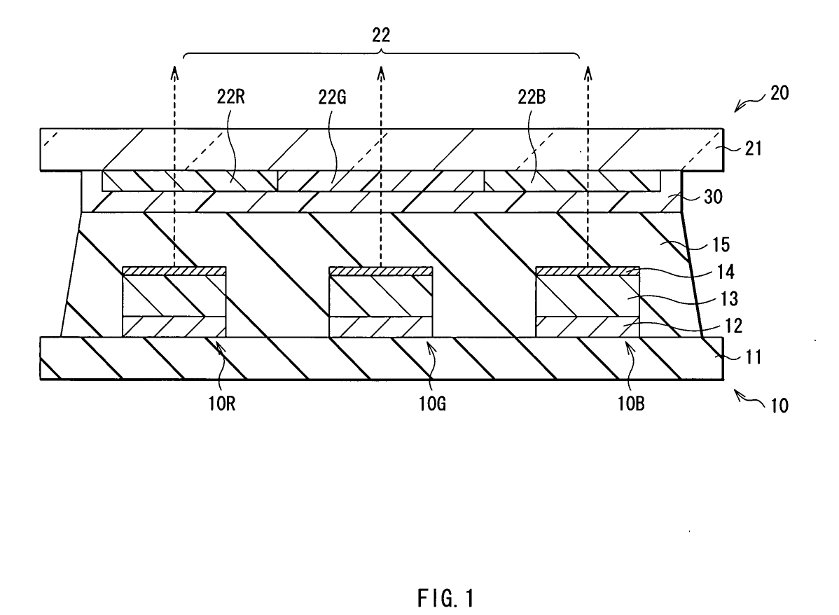

FIG. 1 shows a cross sectional structure of a display unit using organic light emitting devices which are light emitting devices according to a first embodiment of the invention. This display unit is used as an ultrathin organic light emitting color display unit or the like, and, for example, a driving panel 10 and a sealing panel 20 are placed opposite, and their whole faces are bonded together by an adhesive layer 30. The driving panel 10 is provided with an organic light emitting device 10R which emits red lights, an organic light emitting device 10G which emits green lights, and an organic light emitting device 10B which emits blue lights in this order in a matrix state as a whole on a driving substrate 11 made of an insulation material such as glass.

In the organic light emitting devices 10R, 10G, and 10B, for example, a first electrode 12 as an anode, an organic layer 13, and a second electrode 14 as a cathode are layered in this order from the driving substrate 11 side. On the second electrode 14, a protective film 15 is formed as necessary.

The first electrode 12 also has a function as a reflection layer, so that it is desirable that the first electrode 12 has reflectance as high as possible in order to improve light emitting efficiency. For example, in case where a material with high extinction coefficient such as metals is used, it is preferable that a material with low real part refractive index is used as long as possible, and a thickness in layer direction (hereinafter simply referred to as “thickness”) is set to a thickness wherein lights do not pass, specifically a thickness of about 100 nm or more, since reflectance can be raised. Specifically, it is preferable that a thickness of the first electrode 12 is set to, for example, about 200 nm, and the first electrode 12 is made of a simple substance or an alloy of metal elements with high work function, such as platinum (Pt), gold (Au), chromium (Cr), tungsten (W) and the like. Other elements can be added to the above materials for the first electrode 12 to the extent that substantial difference does not occur in terms of optical constant.

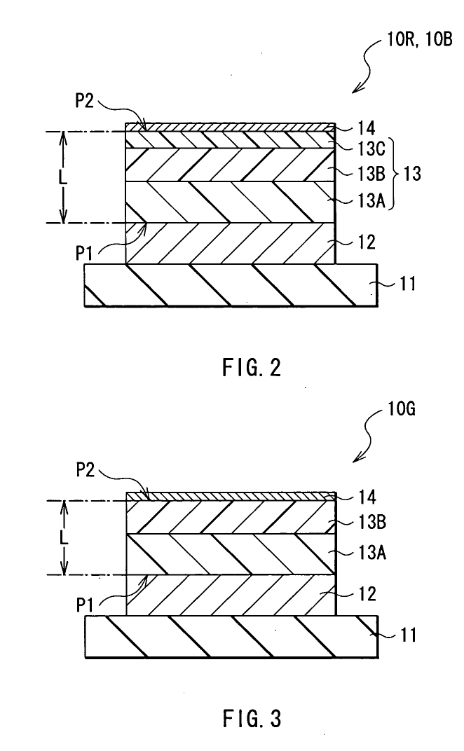

A construction of the organic layer 13 varies according to light emitting colors of the organic light emitting devices 10. FIG. 2 shows an enlarged view of a construction of the organic layer 13 in the organic light emitting devices 10R and 10B. The organic layer 13 of the organic light emitting devices 10R and 10B has a structure wherein an electron hole transport layer 13A, a light emitting layer 13B, and an electron transport layer 13C are layered in this order from the first electrode 12 side. A function of the electron hole transport layer 13A is to improve efficiency to inject electron holes into the light emitting layer 13B. In this embodiment, the electron hole transport layer 13A also has a function as an electron hole injection layer. A function of the light emitting layer 13B is to produce lights by current injection. A function of the electron transport layer 13C is to improve efficiency to inject electrons into the light emitting layer 13B.

The electron hole transport layer 13A of the organic light emitting device 10R, for example, has a thickness of about 45 nm, and made of bis [(N-naphthyl)-N-phenyl] benzidine (α-NPD). The light emitting layer 13B of the organic light emitting device 10R, for example, has a thickness of about 50 nm, and made of 2,5-bis [4-[N-(4-methoxyphenyl)-N-phenylamino]] stilbenzene-1,4-dica-bonitrile (BSB). The electron transport layer 13C of the organic light emitting device 10R, for example, has a thickness of about 30 nm, and made of 8-quinolinol aluminum complex (Alq₃).

The electron hole transport layer 13A of the organic light emitting device 10B, for example, has a thickness of about 30 nm, and made of α-NPD. The light emitting layer 13B of the organic light emitting device 10B, for example, has a thickness of about 30 nm, and made of 4,4′-bis (2,2′-diphenyl vinyl) biphenyl (DPVBi). The electron transport layer 13C of the organic light emitting device 10B, for example, has a thickness of about 30 nm, and made of Alq₃.

FIG. 3 shows an enlarged view of a construction of the organic layer 13 in the organic light emitting device 10G. The organic layer 13 of the organic light emitting device 10G has a structure wherein the electron hole transport layer 13A and the light emitting layer 13B are layered in this order from the first electrode 12 side. The electron hole transport layer 13A also has a function as an electron hole injection layer. The light emitting layer 13B also has a function as an electron transport layer.

The electron hole transport layer 13A of the organic light emitting device 10G, for example, has a thickness of about 50 nm, and made of α-NPD. The light emitting layer 13B of the organic light emitting device 10G, for example, has a thickness of about 60 nm, and made of Alq₃ mixed with coumarin 6 (C6) of 1 vol %.

The second electrode 14 shown in FIGS. 1 to 3, for example, also has a function as a semi-transparent reflection layer. Namely, these organic light emitting devices 10R, 10G, and 10B have a resonator structure wherein lights generated in the light emitting layer 13B are resonated and extracted from a second end P2, by setting an end face of the first electrode 12 on the light emitting layer 13B side to a first end P1, setting an end face of the second electrode 14 on the light emitting layer 13B side to the second end P2, and setting the organic layer 13 to a resonant part. It is preferable that the organic light emitting devices 10R, 10G, and 10B have such a resonator structure, since the lights generated in the light emitting layer 13B generate multiple interference, and act as a kind of narrow band filter, so that a half value width of spectrums of the lights extracted is reduced and color purity can be improved. Further, it is preferable that the organic light emitting devices 10R, 10G, and 10B have such a resonator structure, since outside lights which is incident from the sealing panel 20 can be also attenuated by the multiple interference, and reflectance of outside lights in the organic light emitting devices 10R, 10G, and 10B can be extremely lowered in combination with color filters 22 (refer to FIG. 1) described later.

To that end, it is preferable that an optical distance L between the first end P1 and the second end P2 of the resonator satisfies mathematical formula 1, and a resonant wavelength of the resonator (peak wavelength of a spectrum of a light extracted) corresponds to a peak wavelength of a spectrum of a light desired to be extracted. Actually, it is preferable that the optical distance L is selected to be a positive minimum value which satisfies the mathematical formula 1.

Mathematical formula 1

(2L)/λ+Φ/(2π)=m

(In the expression, L represents an optical distance between the first end P1 and the second end P2, Φ represents a phase shift (rad) of reflected lights generated in the first end P1 and the second end P2, λ represents a peak wavelength of a spectrum of a light desired to be extracted from the second end P2, and m represents an integral number to make L positive, respectively. In the mathematical formula 1, a unit for L and λ should be common, for example, nm is used as a common unit.)

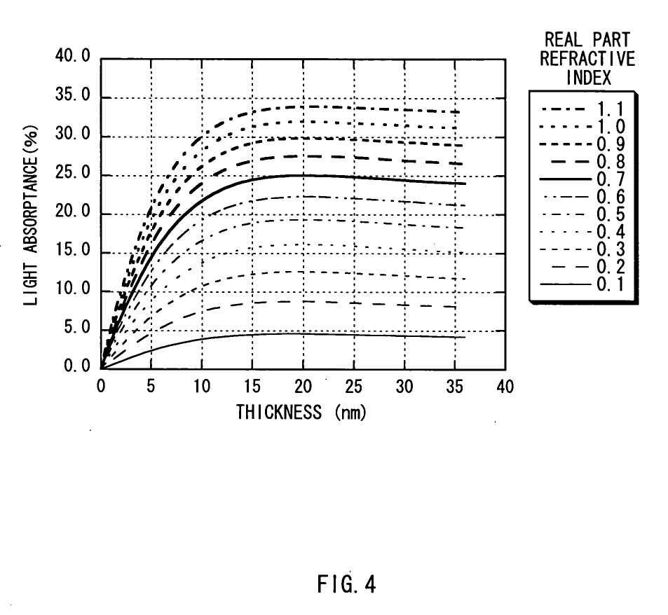

The second electrode 14 is, for example, made of a metal material. It is preferable to select a material with which light absorption becomes small, since a metal material has a high extinction coefficient and generates light absorption in the second electrode 14. Loss by self absorption causes lowering of light emitting efficiency since the absorbed lights are not emitted anywhere. FIG. 4 shows light absorptance in relation to thickness which is obtained by an absorptance calculation method in general optical multi-layer thin films, where extinction coefficient is −4i, and real part refractive index is varied in increments of 0.1 in the range from 0.1 to 1.1 (for example, refer to “Principles of Optics,” Max Born and Emil Wolf, 1974 (PERGAMON PRESS) and the like). From FIG. 4, it is found that the smaller the real part refractive index is, the smaller the light absorption is, which is preferable. Namely, in order to reduce the loss by self absorption, it is preferable that the second electrode 14 is made of a material with which real part refractive index is approximately 1 or less, such as silver (Ag) (0.055-3.32i: 550 nm), aluminum (Al) (0.7-5.0i: 500 nm), magnesium (Mg) (0.57-3.47i: 546 nm), calcium (Ca) (0.7-5.0i: 500 nm), sodium (Na) (0.029-2.32i: 546 nm), gold (0.035-2.40i: 546 nm), copper (Cu) (0.91-2.40i: 540 nm), and platinum (0.92-2.6i: 500 nm). In particular, in the case where the second electrode 14 is used as a cathode as in this embodiment, materials with small work function such as a simple substance or an alloy of aluminum, magnesium, calcium, and sodium among the above examples are suitable. Other elements can be added to the above materials for the second electrode 14 to the extent that substantial difference does not occur in terms of optical constant.

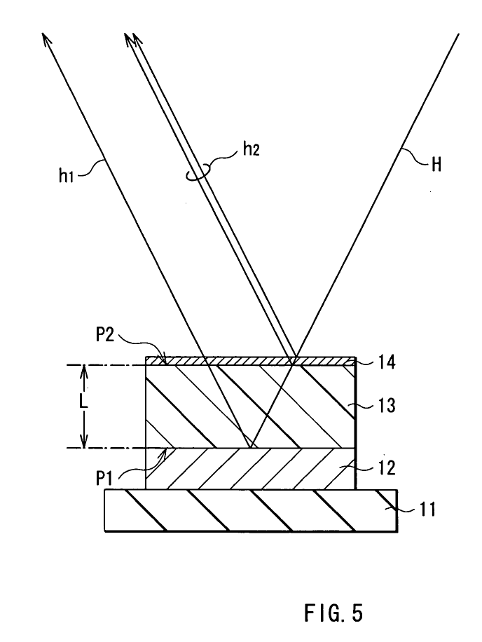

In the organic light emitting devices 10R, 10G, and 10B, reflectance of outside lights in resonant wavelengths which is incident from the second end P2 side is adjusted to be 20% or less. Specifically, regarding reflected lights of outside lights on the first end P1 side and the second end P2 side, respective strengths and phases are adjusted so that reflectance of outside lights in resonant wavelengths become 20% or less, for example, construction is made so that both strengths are approximately the same and respective phases are approximately inverted. It is required to obtain outside lights reflectance of 20% or less, in order to obtain image quality whose level is equal to that of a display unit using a conventional high-contrasted CRT (cathode ray tube). Further, it is preferable that reflectance of outside lights in resonant wavelengths which is incident from the second end P2 side is adjusted to be 15% or less, and it is more preferable that it is adjusted to be 5% or less. Here, the reflected light of an outside light on the first end P1 side represents a composite wave of all reflected lights generated on the first end P1 side, and the reflected light of an outside light on the second end P2 side represents a composite wave of all reflected lights generated on the second end P2 side. In this embodiment, as shown in FIG. 5, a reflected light h1 of an outside light H on the first end P1 side is a reflected light generated on an interface of the first electrode 12 and the organic layer 13, and a reflected light h2 of the outside light H on the second end P2 side is a composite wave of a reflected light generated on an interface of the second electrode 14 and the organic layer 13, and a reflected light generated on an interface of the light emitting layer 13B and an opposite side of the second electrode 14 from the organic layer 13.

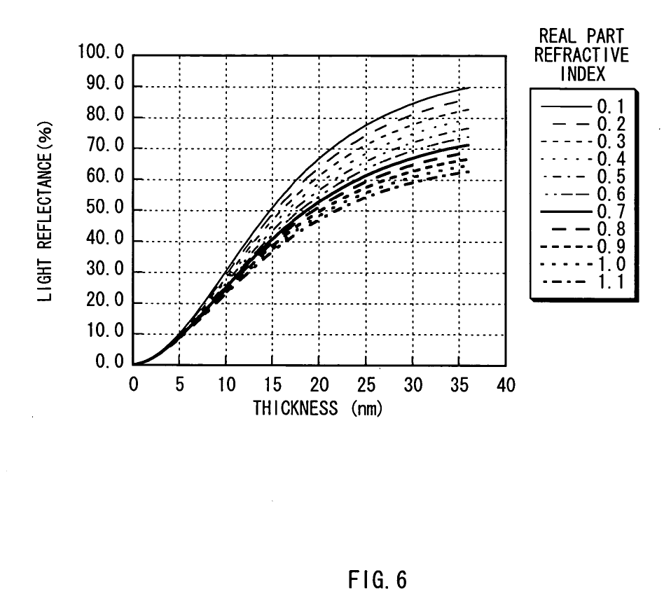

Strengths of the reflected lights h1 and h2 are adjusted by selecting materials and thicknesses of the first electrode 12 and the second electrode 14. FIG. 6 shows light reflectance in relation to thickness which is obtained by a reflectance calculation method in general optical multi-layer thin films, where extinction coefficient is −4i, and real part refractive index is varied in increments of 0.1 in the range from 0.1 to 1.1. From FIG. 6, it is found that light reflectance can be changed from 0% up to 90% by changing thicknesses or materials of the electrodes, and also found that the smaller the refractive index is, the wider the feasible range of light reflectance is. In particular, it is preferable that refractive index is 1 or less since light reflectance can be changed from 0% to about 70% or more.

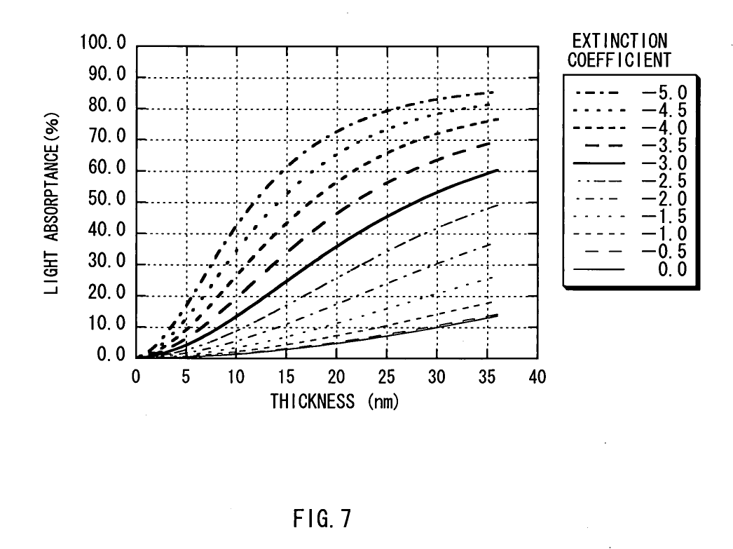

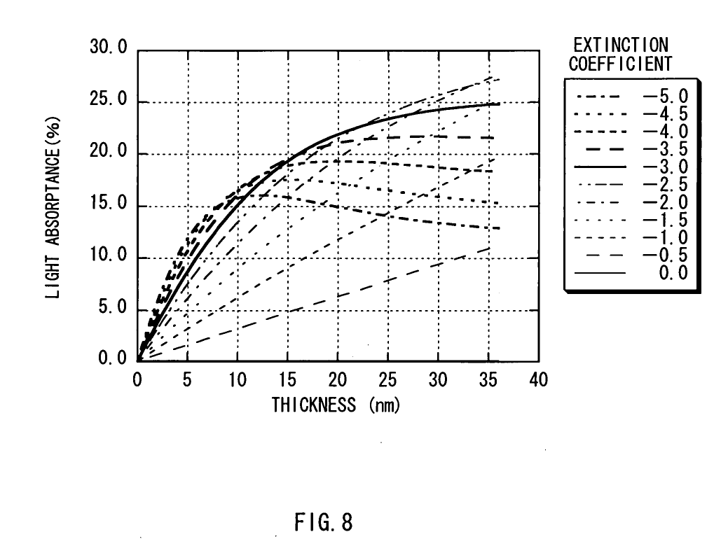

FIG. 7 shows light reflectance in relation to thickness of electrode where refractive index is 0.5 and extinction coefficient is varied in increments of 0.5 in the range from 0 to −5.0, and FIG. 8 shows light absorptance in relation to thickness of electrode where refractive index is 0.5 and extinction coefficient is varied in increments of 0.5 in the range from 0 to −5.0, respectively. These light reflectance and light absorptance are obtained by a calculation method for general optical multi-layer thin films. As shown in FIG. 7, it is preferable that extinction coefficient is −0.5 or less (0.5 or more), since light reflectance can be varied from 0% to about 80% or more. Further, it is more preferable that extinction coefficient is −2.0 or less (2 or more), since feasible value range of light reflectance becomes large, and light reflectance can be varied from 0% to about 90% or more. However, as shown in FIG. 8, since light absorptance becomes large as well, it is preferable to adjust a thickness of the electrode so that light absorptance becomes small as long as possible.

When the optical distance L between the first end P1 and the second end P2 satisfies mathematical formula 1, phases of reflected light of outside light are adjusted so that the reflected lights h1 and h2 shown in FIG. 5 are approximately inverted.

The protective film 15 shown in FIG. 1, for example, has a thickness of 500 nm to 10,000 nm, and is a passivation film composed of a transparent dielectric. The protective film 15 is made of, for example, silicon oxide (SiO₂), and silicon nitride (SiN).

As shown in FIG. 1, the sealing panel 20 is located on the second electrode 14 side of the driving panel 10, and comprises a sealing substrate 21 to seal the organic light emitting devices 10R, 10G, and 10B with the adhesive layer 30. The sealing substrate 21 is made of a material such as glass which is transparent to lights generated in the organic light emitting devices 10R, 10G, and 10B. In the sealing substrate 21, for example, the color filters 22 are provided, so that lights generated in the organic light emitting devices 10R, 10G, and 10B are extracted, outside lights reflected in the organic light emitting devices 10R, 10G, and 10B and wiring between them are absorbed, and contrast is improved.

The color filters 22 can be provided either side of the sealing substrate 21. However, it is preferable to provide the color filters 22 on the driving panel 10 side, since the color filters 22 are not exposed on the surface, and can be protected by the adhesive layer 30. The color filters 22 comprise a red filter 22R, a green filter 22G, and a blue filter 22B, which are arranged corresponding to the organic light emitting devices 10R, 10G, and 10B in this order.

The red filter 22R, the green filter 22G, and the blue filter 22B are respectively, for example, formed in the shape of rectangle without space between them. The red filter 22R, the green filter 22G, and the blue filter 22B are respectively made of a resin mixed with a pigment. The red filter 22R, the green filter 22G, and the blue filter 22B are adjusted so that light transmittance in the targeted red, green, or blue wavelength band becomes high and light transmittance in other wavelength bands becomes low by selecting a pigment.

Further, a wavelength range with high transmittance in the color filters 22 corresponds to a peak wavelength λ of a spectrum of a light extracted from the resonator structure. Therefore, among the outside lights h which is incident from the sealing panel 20, only the lights having a wavelength equal to a peak wavelength λ of a spectrum of a light extracted pass through the color filters 22, and other outside lights h having other wavelengths are prevented from intruding into the organic light emitting devices 10R, 10G, and 10B.

These organic light emitting devices 10R, 10G, and 10B, for example, can be manufactured as below.

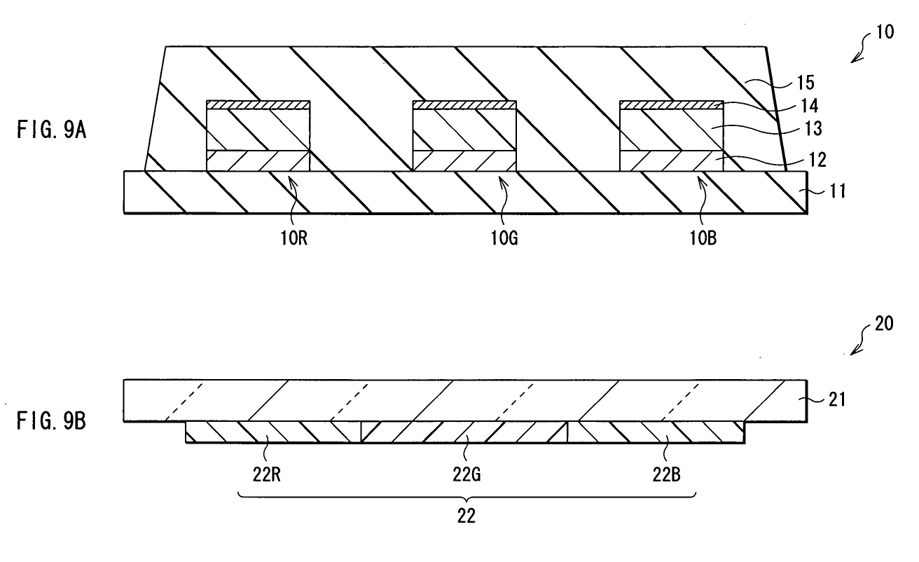

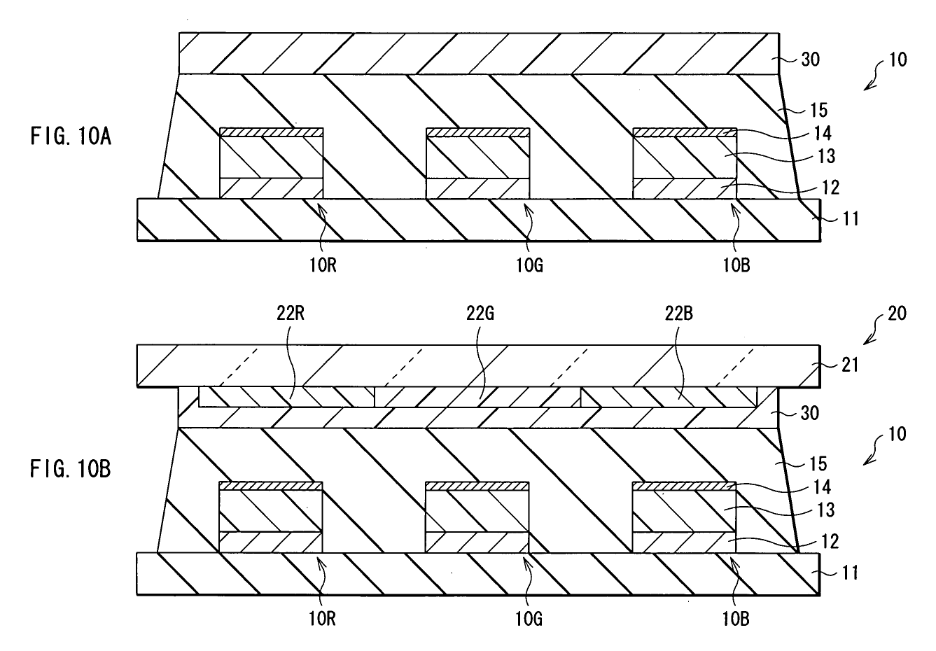

FIGS. 9A, 9B, 10A, and 10B show a method of manufacturing this display unit in order of processes. First, as shown in FIG. 9A, on the driving substrate 11 made of the foregoing material, the first electrode 12 made of the foregoing material is deposited in the foregoing thickness by, for example, DC spattering, selective etching is made by using, for example, lithography technique, and patterning is made in a given shape. After that, as shown in FIG. 9A as well, the electron hole transport layer 13A, the light emitting layer 13B, the electron transport layer 13C, and the second electrode 14 which have the foregoing thicknesses and are made of the foregoing materials are sequentially deposited by, for example, deposition method, and the organic light emitting devices 10R, 10G, and 10B as shown in FIGS. 2 and 3 are formed. After that, on the second electrode 14, the protective film 15 is formed as necessary. Consequently, the driving panel 10 is formed.

In addition, as shown in FIG. 9B, for example, the red filter 22R is formed by applying a material for the red filter 22R on the sealing substrate 21 made of the foregoing material by spin coat and the like, and applying patterning by photolithography technique and firing. Subsequently, as shown in FIG. 9B as well, as in the red filter 22R, the blue filter 22B and the green filter 22G are sequentially formed. Consequently, the sealing panel 20 is formed.

After forming the sealing panel 20 and the driving panel 10, as shown in FIG. 10A, the adhesive layer 30 is formed on the protective film 15. After that, as shown in FIG. 10B, the driving panel 10 and the sealing panel 20 are bonded together with the adhesive layer 30 in between. Then, a face of the sealing panel 20 where the color filters 22 are formed are preferably placed opposite to the driving panel 10. Consequently, the driving panel 10 and the sealing panel 20 are bonded, and the display unit shown in FIGS. 1 to 3 is completed.

In this display unit, when a given voltage is applied between the first electrode 12 and the second electrode 14, current is injected into the light emitting layer 13B, and an electron hole and an electron recombine, leading to light emitting mainly at the interface of the light emitting layer 13B. This light is multiply reflected between the first electrode 12 and the second electrode 14, and extracted through the second electrode 14, the protective layer 15, the color filters 22, and the sealing substrate 21. Then, outside lights being incident from the sealing substrate 21 side, and outside lights with wavelengths other than resonant wavelengths are absorbed in the color filters 22, and attenuated by multiple interference in the organic light emitting devices 10R, 10G, and 10B. Meanwhile, outside lights with resonant wavelengths pass through the color filters 22, enter into the organic light emitting devices 10R, 10G, and 10B, and are reflected mainly in the second electrode 14 and the first electrode 12. However, in this embodiment, construction is made so that reflectance in the organic light emitting devices 10R, 10G, and 10B becomes 20% or less by adjusting respective strengths and phases regarding reflected lights of outside lights on the first end P1 side, i.e. on the first electrode 12 and on the second end P2 side, i.e. on the second electrode 14. Therefore, reflected lights which pass through the sealing substrate 21 and are extracted become very little. Consequently, outside lights reflection or reflection of outside scenes are reduced.

As above, according to this embodiment, reflectance of the outside light H in a resonant wavelength which is incident from the second end P2 side, i.e. the second electrode 14 side is set to 20% or less. Therefore, outside lights reflection or reflection of outside scenes can be reduced, and image quality can be improved.

In particular, when extinction coefficient of the second electrode 14 is set to 0.5 or more, or further set to 2 or more, feasible value range of light reflectance for the second electrode 14 can be widened. Therefore, adjustment of strength of the reflected lights h1 and h2 on the first end P1 side and the second end P2 side can be easily made so that reflectance of the outside light H in a resonant wavelength becomes 20% or less.

Further, particularly, when refractive index of the second electrode 14 is set to 1 or less, absorption in the second electrode 14 can be lowered, and the lights generated in the light emitting layer 13B can be efficiently extracted.

### Second embodiment

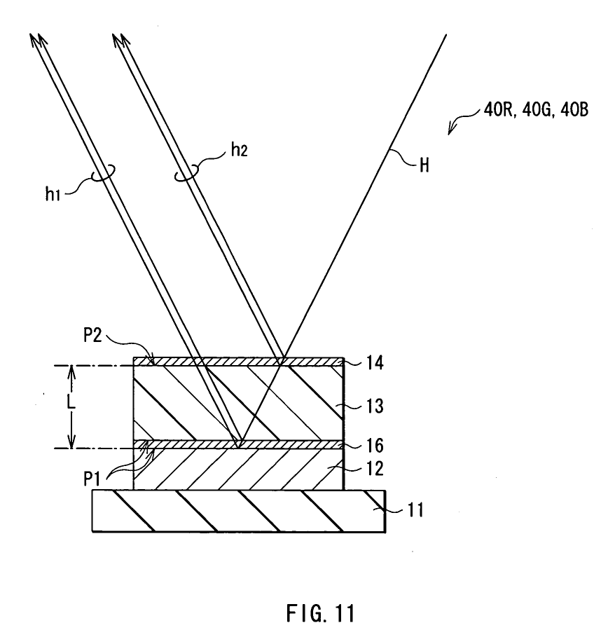

FIG. 11 shows a cross sectional structure of an organic light emitting device which is a display element according to a second embodiment of the invention. Organic light emitting devices 40R, 40G, and 40B are identical with the organic light emitting devices 10R, 10G, and 10B explained in the first embodiment except that a thin film layer for electron hole injection 16 is formed between the first electrode 12 and the organic layer 13. Therefore, the same components are applied with the same symbols, and their detailed explanations are omitted.

A function of the thin film layer for electron hole injection 16 is to improve efficiency to inject electron holes into the organic layer 13. The thin film layer for electron hole injection 16 is made of a material with high work function than the material of the first electrode 12. In addition, the thin film layer for electron hole injection 16 also has a function as a protective film which eases damage to the first electrode 12 also in a manufacturing process after forming the first electrode 12. Materials to make the thin film layer for electron hole injection 16 include, for example, metals such as chrome, nickel (Ni), cobalt (Co), molybdenum (Mo), platinum and silicon (Si), alloys including at least one of these metals, oxides or nitrides of these metals or alloys, and transparent conductive materials such as ITO (indium-tin oxide: oxide mixture film of indium (In) and tin (Sn)). A thickness of the thin film layer for electron hole injection 16 is preferably determined corresponding to light transmittance and conductivity of construction materials. For example, in the case where the thin film layer for electron hole injection 16 is made of an oxide or a nitride whose conductivity is not so high such as chromic oxide (III) (Cr₂O₃), the thickness is preferably thin, for example, about 5 nm. In the case where the thin film layer for electron hole injection 16 is made of a metal whose conductivity is high and transmittance is low, the thickness is also preferably thin, for example several nm. Meanwhile, in the case where the thin film layer for electron hole injection 16 is made of ITO whose conductivity and transmittance are high, it is possible to make its thickness thick to about several nm to several dozen nm. In this embodiment, the thin film layer for electron hole injection 16 is made of, for example, chromic oxide (II) (CrO).

As in this embodiment, when the thin film layer for electron hole injection 16 is provided, the reflected light h1 of the outside light H on the first end P1 side is a composite wave of a reflected light generated on an interface of the first electrode 12 and the thin film layer for electron hole injection 16, and a reflected light generated on an interface of the thin film layer for electron hole injection 16 and the organic layer 13. Which reflected light on the foregoing two interfaces is bigger depends on a material for the thin film layer for electron hole injection 16. For example, when the thin film layer for electron hole injection 16 is made of a material whose optical constant is close to that of the organic layer 13, such as chromic oxide (II), the reflected light generated on the interface of the first electrode 12 and the thin film layer for electron hole injection 16 becomes bigger than the other reflected light, the thin film layer for electron hole injection 16 is included in a resonant part, and the first end P1 becomes an interface of the first electrode 12 and the thin film layer for electron hole injection 16. Meanwhile, for example, when the thin film layer for electron hole injection 16 is made of a metal such as platinum (Pt), the reflected light generated on the interface of the thin film layer for electron hole injection 16 and the organic layer 13 becomes bigger than the other reflected light, the thin film layer for electron hole injection 16 is not included in the resonant part, and the first end P1 becomes an interface of the thin film layer for electron hole injection 16 and the organic layer 13.

An effect similar to that in the foregoing first embodiment can be obtained by the above construction.

### EXAMPLE

Further, concrete examples of the invention will be described below.

### Example 1

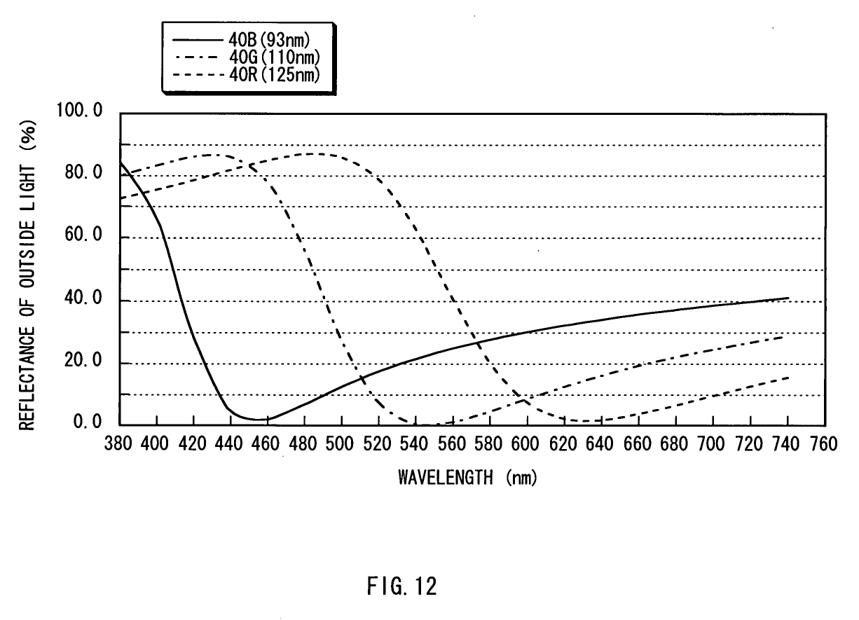

The organic light emitting devices 40R, 40G, and 40B which had a construction similar to that in the foregoing second embodiment were respectively made. Then, the first electrode 12 was made of aluminum, or an aluminum alloy including aluminum of 98 wt %, and its thickness was set to 200 nm. The thin film layer for electron hole injection 16 was made of chromic oxide (II), and its thickness was set to 4 nm. The organic layer 13 was made of the material exemplified in the foregoing embodiments, and its total thickness was 125 nm in the organic light emitting device 40R, 110 nm in the organic light emitting device 40G, and 93 nm in the organic light emitting device 40B. Among the organic layer 13, refractive index of a layer adjacent to the second electrode 14, namely, the electron transport layer 13C in the organic light emitting devices 40R and 40B, or the light emitting layer 13B in the organic light emitting device 40G was approximately 1.7. The second electrode 14 was made of a material similar to that of the first electrode 12, and its thickness was set to 17 nm. The protective film 15 was made of a material with refractive index of 1.5. By adjusting materials and thicknesses of the first electrode 12, the second electrode 14 and the like, and the optical distance L of the organic layer 13 in this way, the reflected light h1 of the outside light H in a resonant wavelength at the first electrode 12 and the reflected light h2 of the outside light H in a resonant wavelength at the second electrode 14 were set so that they had almost the same strength and their phases were approximately inverted. Regarding the manufactured organic light emitting devices 40R, 40G, and 40B, by making outside lights being incident from the second electrode 14 side at an angle of 0 degree, each reflectance was examined. FIG. 12 shows reflectance spectrums of the organic light emitting devices 40R, 40G, and 40B. As shown in FIG. 12, regarding the organic light emitting device 40R, reflectance of outside lights near a resonant wavelength of 630 nm became 2%. Regarding the organic light emitting device 40G, reflectance of outside lights near a resonant wavelength of 540 nm became 0.5%. Regarding the organic light emitting device 40B, reflectance of outside lights near a resonant wavelength of 450 nm became 2%.

### Example 2

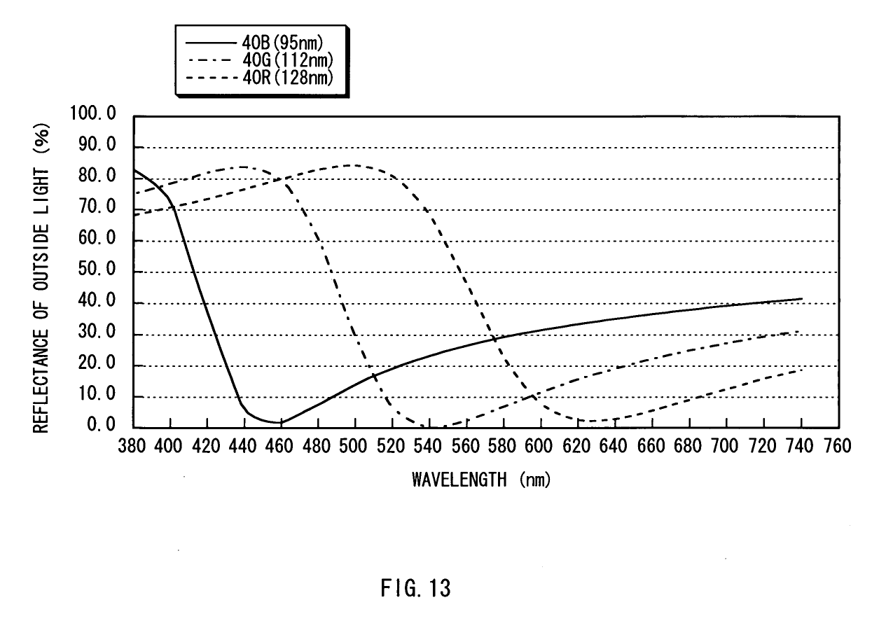

The organic light emitting devices 40R, 40G, and 40B were respectively made as in Example 1 except that thicknesses of the organic layer 13 and the second electrode 14 were changed and a material of the protective film 15 was changed. The reflected light h1 in a resonant wavelength at the first electrode 12 and the reflected light h2 in a resonant wavelength at the second electrode 14 were set so that they had approximately the same strength and their phases were inverted. A total thickness of the organic layer 13 was 128 nm in the organic light emitting device 40R, 112 nm in the organic light emitting device 40G, and 95 nm in the organic light emitting device 40B. A thickness of the second electrode 14 was set to 17 nm. The protective film 15 was made of a material with refractive index of 1.9. Regarding the manufactured organic light emitting devices 40R, 40G, and 40B, by making outside lights being incident from the second electrode 14 side at an angle of 0 degree, each reflectance was examined. FIG. 13 shows reflection spectrums of the organic light emitting devices 40R, 40G, and 40B. As shown in FIG. 13, regarding the organic light emitting device 40R, reflectance of outside lights near a resonant wavelength of 630 nm became 2%, so that the same result as in Example 1 could be obtained. Regarding the organic light emitting device 40G, reflectance of outside lights near a resonant wavelength of 540 nm became 0.5%, so that the same result as in Example 1 could be obtained. Regarding the organic light emitting device 40B, reflectance of outside lights near a resonant wavelength of 450 nm became 3%, so that approximately the same result as in Example 1 could be obtained.

Namely, it was found that regarding the reflected light h1 of the outside light H in a resonant wavelength on the first end P1 side and the reflected light h2 of the outside light H in a resonant wavelength on the second end P2 side, when their strengths and phases are adjusted, reflectance can be 20% or less, and image quality can be improved.

While the invention has been described with reference to the embodiments, the invention is not limited to the foregoing embodiments, and various modifications may be made. For example, materials, thickness, deposition methods, and deposition conditions for each layer are not limited to those described in the foregoing embodiments, and other materials, thicknesses, deposition methods, and deposition conditions can be applied. For example, though in the foregoing embodiments, the case wherein the first electrode 12, the organic layer 13, and the second electrode 14 are layered on the driving substrate 11 in this order from the driving substrate 11 side, and lights are extracted from the sealing panel 20 side has been described, it is also possible that the second electrode 14, the organic layer 13 and the first electrode 12 are layered on the driving substrate 11 from the driving substrate 11 side in the opposite order to the above-mentioned order, and lights are extracted from the driving substrate 11 side.

Further, for example, though in the foregoing embodiments, the case using the first electrode 12 as an anode and using the second electrode 14 as a cathode has been described, it is possible to adversely use the first electrode 12 as a cathode and use the second electrode 14 as an anode. In this case, as a material for the second electrode 14, a simple substance or an alloy of gold, silver, platinum, copper and the like that have high work function is suitable. However, other materials can be used by providing the thin film layer for electron hole injection 16. Further, other elements can be added to the above materials for the second electrode 14 to the extent that substantial difference does not occur in terms of optical constant. Furthermore, it is possible that along with using the first electrode 12 as a cathode and the second electrode 14 as an anode, the second electrode 14, the organic layer 13, and the first electrode 12 are layered on the driving substrate 11 in this order from the driving substrate 11 side, and lights are extracted from the driving substrate 11 side.

Further, though in the foregoing embodiments, the constructions of the organic light emitting devices have been specifically described, not all the layers such as the thin film layer for electron hole injection 16 and the protective film 15 should be provided, and other layers can be further provided. For example, the first electrode 12 can have a two-layer structure wherein a transparent conductive film is layered on a reflection film such as a dielectric multi-layered film and Al. In this case, an end face of this reflection film on the light emitting layer side constructs an end of a resonant part, and the transparent conductive film constructs a part of the resonant part.

Further, though in the foregoing embodiments, the case wherein the second electrode 14 is comprised of the semi-transparent reflection layer has been described, the second electrode 14 can have a structure wherein a semi-transparent reflection layer and a transparent electrode are layered in this order from the first electrode side. This transparent electrode is used for lowering an electric resistance of the semi-transparent reflection layer, and is made of a conductive material having sufficient translucency to the lights generated in the light emitting layer. As a material to make the transparent electrode, for example, ITO, or a compound containing indium, zinc (Zn), and oxygen is preferable, since good conductivity can be obtained by using these materials even if deposition is made at room temperature. A thickness of the transparent electrode can be, for example, from 30 nm to 1,000 nm. In this case, it is possible to form a resonator structure by setting the semi-transparent reflection layer to one end, providing the other end in the position opposing to the semi-transparent electrode sandwiching the transparent electrode, and setting the transparent electrode to a resonant part. Further, in the case where such a resonator structure is provided, it is preferable that the protective film 15 is made of a material having refractive index approximately equal to that of the material making the transparent electrode, since the protective film 15 can be a part of the resonant part.

Further, the invention can be applied to the case wherein the second electrode 14 is comprised of the transparent electrode, reflectance of an end face of this transparent electrode located opposite to the organic layer 13 is constructed to be large, and a resonator structure is constructed by using an end face of the first electrode 12 on the light emitting layer 13B side as the first end, and using an end face of the transparent electrode located opposite to the organic layer as the second end. For example, it is possible that reflectance on an interface of the protective film 15 and the adhesive layer 30 is made large, and this interface is set to the second end. Further, it is possible that no protective film 15 and no adhesive layer 30 are provided, the transparent electrode is contacted to atmospheric region, reflectance on the interface of the transparent electrode and the atmospheric region is made large, and this interface is set to the second end.

As described above, according to the light emitting devices of the invention and the display unit of the invention, since reflectance of outside lights in resonant wavelengths which is incident from the second end side is set to 20% or less, outside lights reflection or reflection of outside scenes can be reduced, and image quality can be improved.

According to the light emitting devices of one aspect of the invention or the display unit of one aspect of the invention, since extinction coefficient of the semi-transparent reflection layer is set to 0.5 or more, feasible value range of reflectance for the semi-transparent reflection layer can be widened. Therefore, it is possible to easily adjust strengths of reflected lights on the first end side and the second end side so that reflectance of outside lights in resonant wavelengths becomes 20% or less.

According to the light emitting devices of another aspect of the invention, or the display unit of another aspect of the invention, since refractive index of the semi-transparent reflection layer is set to 1 or less, absorption in the semi-transparent reflection layer can be small, and the lights generated in the light emitting layer can be extracted efficiently.

Obviously many modifications and variations of the present invention are possible in the light of the above teachings. It is therefore to be understood that within the scope of the appended claims the invention may be practiced otherwise than as specifically described.

What is claimed is:

1. A light emitting device having a resonator structure which resonates lights generated in a light emitting layer between a first end and a second end, and extracting lights at least from the second end side, wherein:
reflectance of outside lights in resonant wavelengths which is incident from the second end side is 20% or less.

2. A light emitting device according to claim 1, wherein respective strengths and phases of reflected lights of the outside lights on the first end side and the second end side are adjusted so that reflectance of the outside lights becomes 20% or less.

3. A light emitting device according to claim 1, wherein an organic layer including the light emitting layer is provided between the first end and the second end.

4. A light emitting device according to claim 1, wherein a semi-transparent reflection layer is provided on the second end, and extinction coefficient of the semi-transparent reflection layer is 0.5 or more.

5. A light emitting device according to claim 4, wherein the semi-transparent reflection layer has refractive index of 1 or less.

6. A light emitting device according to claim 1, wherein an optical distance satisfies mathematical formula 1, where a phase shift of reflected lights generated in the first end and the second end is Φ, the optical distance between the first end and the second end is L, and a peak wavelength of a spectrum of a light desired to be extracted from the second end side is λ.
Mathematical formula 1
(2L)/λ+Φ/(2π)=m (m is an integer which makes L positive.)

7. A light emitting device according to claim 1, wherein color filters which transmit the lights extracted from the second end part side are provided.

8. A display unit comprising light emitting devices having a resonator structure which resonates lights generated in a light emitting layer between a first end and a second end, and extracting lights at least from the second end side, wherein:
reflectance of outside lights in resonant wavelengths which is incident from the second end side is 20% or less.

9. A display unit according to claim 8, wherein respective strengths and phases of reflected lights of the outside lights on the first end side and the second end side are adjusted so that reflectance of the outside lights becomes 20% or less.

10. A display unit according to claim 8, wherein an organic layer including the light emitting layer is provided between the first end and the second end.

11. A display unit according to claim 8, wherein a semi-transparent reflection layer is provided on the second end, and extinction coefficient of the semi-transparent reflection layer is 0.5 or more.

12. A display unit according to claim 11, wherein the semi-transparent reflection layer has refractive index of 1 or less.

13. A display unit according to claim 8, wherein an optical distance satisfies mathematical formula 2, where a phase shift of reflected lights generated in the first end and the second end is Φ, the optical distance between the first end and the second end is L, and a peak wavelength of a spectrum of a light desired to be extracted from the second end side is λ.
Mathematical formula 2
(2L)/λ+Φ/(2π)=m (m is an integer which makes L positive.)

14. A display unit according to claim 8, wherein color filters which transmit the lights extracted from the second end part side are provided.
